(19) United States
(12) Patent Application Publication
(10) Pub. No.: US 2008/0284391 A1
(43) Pub. Date: Nov. 20, 2008

(54) FAULT PROTECTION CIRCUIT, METHOD OF OPERATING A FAULT PROTECTION CIRCUIT AND A VOLTAGE REGULATOR EMPLOYING THE SAME

(75) Inventors: Mohammad A. Al-Shyoukh, Richardson, TX (US); Eric C. Blackall, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/967,506

(22) Filed: Dec. 31, 2007

Related U.S. Application Data
(60) Provisional application No. 60/882,680, filed on Dec. 29, 2006.

(51) Int. Cl. G05F 1/569

(52) U.S. Cl. 323/276; 361/18

(57) ABSTRACT

Embodiments of the present disclosure provide a fault protection circuit, a method of operating a fault protection circuit and a voltage regulator. In one embodiment, the fault protection circuit is for use with the voltage regulator and includes an output power section having first and second MOS transistors configured to provide a regulated voltage on an output node of the voltage regulator. The fault protection circuit also includes a gate pull-down section connected to the first and second MOS transistors and configured to provide a gate pull-down MOS transistor to limit a current through the first and second MOS transistors during a current overload fault condition on the output node.

### CROSS-REFERENCE TO PROVISIONAL APPLICATION

This application claims the benefit of U.S. Provisional Application No. 60/882,680 entitled “Composite Power FET Structure for Linear Voltage Regulators with Negative Short Protection” to Mohammad A. Al-Shyoukh and Eric Blackall, filed on Dec. 29, 2006 which is incorporated herein by reference in its entirety.

### TECHNICAL FIELD

The present disclosure is directed, in general, to voltage regulation and, more specifically, to a fault protection circuit, a method of operating a fault protection circuit and a voltage regulator employing the circuit or the method.

### BACKGROUND

A low dropout voltage (LDO) regulator is a linear DC voltage regulator characterized by having a small input to output differential voltage, which reduces power dissipation associated with lower overall power supply efficiency. The LDO regulator also uses only a few critical components that include an error amplifier connected to a reference voltage and an error signal that is proportional to the output voltage. The error amplifier maintains the output voltage as load current varies. LDO regulators are broadly applied in hostile environments that may contain opportunity for the regulated output to become faulted. Regulators can deal with some fault conditions. Nevertheless, improvements in dealing with faults would prove beneficial in the art.

### SUMMARY

Embodiments of the present disclosure provide a fault protection circuit, a method of operating a fault protection circuit and a voltage regulator. In one embodiment, the fault protection circuit is for use with a voltage regulator and includes an output power section having first and second MOS transistors configured to provide a regulated voltage on an output node of the voltage regulator. The fault protection circuit also includes a gate pull-down section connected to the first and second MOS transistors and configured to provide a gate pull-down MOS transistor to limit a current through the first and second MOS transistors during a current overload fault condition on the output node.

In another aspect, the present disclosure provides a method of operating a fault protection circuit for use with a voltage regulator. The method includes providing a regulated voltage on an output node of the voltage regulator employing first and second MOS transistors and limiting a current through the first and second MOS transistors during a current overload fault condition on the output node employing a gate pull-down MOS transistor.

The present disclosure also provides, in yet another aspect, a voltage regulator. The voltage regulator includes an error amplifier having a control signal output, a first differential input connected to a reference voltage and a second differential input connected to an error signal. The voltage regulator also includes an error signal generator that provides the error signal corresponding to an error in a regulated voltage on an output node of the voltage regulator. The voltage regulator further includes a fault protection circuit connected to the control signal output having an output power section with first and second MOS transistors that provide a regulated voltage on an output node of the voltage regulator. The fault protection circuit also has a gate pull-down section connected to the first and second MOS transistors that provides a gate pull-down MOS transistor to limit a current through the first and second MOS transistors during a current overload fault condition on the output node. The fault protection circuit further has an oxide protection section connected to the gate pull-down section that limits voltages across the first, second and gate pull-down MOS transistors during a voltage breakdown fault condition on the output node.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 illustrates a system diagram of a voltage regulator as provided by one embodiment of the disclosure;

FIG. 2 illustrates a sectioned view of an isolation structure containing a gate pull-down MOS transistor as may be employed with the voltage regulator of FIG. 1; and

FIG. 3 illustrates a flow diagram of an embodiment of a method of operating a fault protection circuit carried out according to the principles of the present disclosure.

### DETAILED DESCRIPTION

Fault conditions within a regulation range of a voltage regulator are typically accommodated by normal functioning of the voltage regulator. Embodiments of the present disclosure provide protection for the voltage regulator that may encounter fault conditions to voltages that are outside its regulation range. Embodiments discussed below protect the voltage regulator from two types of fault conditions on its output. A current overload fault condition, if not limited, may cause an output current of at least one regulator component to increase to the point of regulator failure. Similarly, a voltage breakdown fault condition, if not limited, would typically cause at least one critical regulator component to fail due to voltage overload.

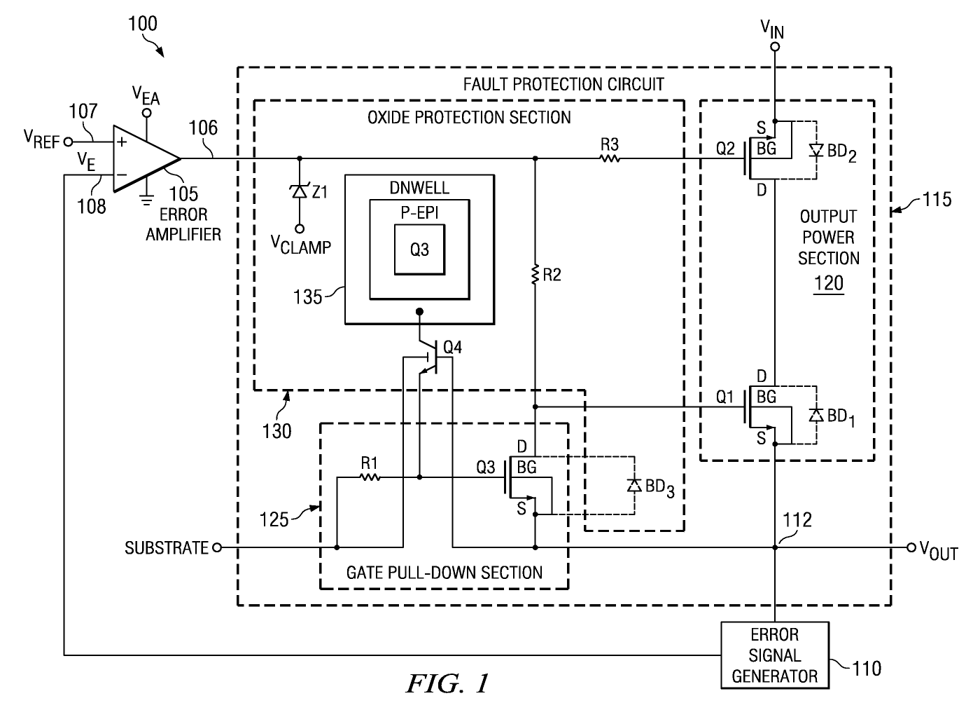

FIG. 1 illustrates a system diagram of a voltage regulator 100 as provided by one embodiment of the disclosure. Although embodiments of the present disclosure may employ transistors of either polarity, an example employing n-type transistors is discussed with respect to FIG. 1. The voltage regulator 100 includes an error amplifier 105, an error signal generator 110 and a fault protection circuit 115. The error amplifier 105 includes a control signal output 106, a first differential input 107 connected to a reference voltage V_{REF} and a second differential input 108 connected to an error signal V_{E}. In the present embodiment, the error amplifier 105 is connected between a positive supply voltage V_{EA} and ground, as shown. The error signal generator 110 provides the error signal V_{E} corresponding to an error in a regulated output voltage V_{OUT} on an output node 112 of the voltage regulator 100.

The fault protection circuit 115 is connected to the control signal output 106 and includes an output power section 120, a gate pull-down section 125 and an oxide protection section 130. The output power section 120 includes first and second NMOS transistors Q1, Q2 that provide the regulated output voltage V_{OUT} on the output node 112. The first and second NMOS transistors Q1, Q2 have bulk or back gate connections (BG) connected to their respective sources (S), drains (D) connected together and first and second body diodes BD₁, BD₂ connected as shown.

The gate pull-down section 125 is connected to the first and second NMOS transistors Q1, Q2 and includes a gate pull-down NMOS transistor Q3 having a back gate (BG) connected to its source (S), and a third body diode BD₃ connected as shown. The gate pull-down NMOS transistor Q3 limits a current through the first and second NMOS transistors Q1, Q2 during a current overload fault condition on the output node 112. The gate pull-down section 125 also includes a first resistor R1 connected between a substrate of the voltage regulator 100 and the gate of the gate pull-down NMOS transistor Q3, as shown. The gate pull-down NMOS transistor Q3 is a lower threshold voltage device (e.g., 0.7 volts) than the first NMOS transistor Q1 (e.g., 1.5 volts).

The oxide protection section 130 is connected to the gate pull-down section 125 and limits voltages across the first, second and gate pull-down transistors Q1, Q2, Q3 during a voltage breakdown fault condition on the output node 112. The oxide protection section 130 includes the third body diode BD₃ of the gate pull-down NMOS transistor Q3, second and third resistors R2, R3, a zener diode Z1 connected to a clamp voltage V_{CLAMP}, an isolation structure 135 and an NPN bipolar transistor Q4. The gate pull-down NMOS transistor Q3 is contained in the isolation structure 135 that allows a voltage difference to be provided between the gate pull-down NMOS transistor Q3 and the substrate during the voltage breakdown fault condition. The NPN bipolar transistor Q4 controls a value of the voltage difference corresponding to the voltage breakdown fault condition.

In normal operation, the voltage regulator 100 provides the regulated output voltage V_{OUT} through a control loop containing the error amplifier 105, the output power section 120 and the error signal generator 110. If the regulated output voltage V_{OUT} varies from its nominal value, the error signal V_{E} generates a correcting signal on the control signal output 106 to restore the nominal value. In the illustrated embodiment, the regulated output voltage V_{OUT} is about five volts, which is provided from an input voltage V_{IN} that is about seven volts. An error amplifier supply voltage V_{EA} of about 12 volts is employed to provide sufficient regulation range for the error amplifier 105. However, the regulated output voltage V_{OUT} is constrained to a range between about zero and seven volts, for normal operation.

Generally, the current overload fault condition would occur for any fault voltage on the output node 112 that is less than the negative supply voltage of the error amplifier 105, for the transistor polarities shown. In the illustrated embodiment, the current overload fault condition corresponds to a negative fault voltage that is connected to the output node 112.

For example, suppose that a negative two (−2) volts is applied to the output node 112. Since the gate of the gate pull-down NMOS transistor Q3 is referenced through the first resistor R1 to the substrate (which is tied to zero volts in this example) the gate pull-down NMOS transistor Q3 conducts and pulls the gate of the first NMOS transistor Q1 so that it is negative. This action limits the current of the first NMOS transistor Q1 (or deactivates it) since its gate voltage is constrained or clamped by the low threshold voltage gate pull-down NMOS transistor Q3. This prevents or limits output current at output node 112, thereby protecting the first and second NMOS transistors Q1, Q2 from current overload.

Generally, the voltage breakdown fault condition would occur for any fault voltage on the output node 112 that is more than the input voltage V_{IN}, for the transistor polarities shown. In the illustrated embodiment, the voltage breakdown fault condition corresponds to a positive fault voltage that is greater than seven volts on the output node 112. Each of the first, second and gate pull-down NMOS transistors Q1, Q2, Q3 have oxide breakdown voltages of about 13 volts, which prohibits a gate-to-source voltage of more than 13 volts. For example, suppose a positive fault voltage of 40 volts is applied to the output node 112.

With 40 volts on the output node 112, the third body diode BD₃ conducts and clamps the gate of the first NMOS transistor Q1 to about 39 volts thereby protecting it from voltage breakdown. The zener diode Z1 provides a zener voltage of about 12 volts to the junction of the second and third resistors R2, R3. Since the input voltage V_{IN} is about seven volts, there is a gate-to-source voltage of about five volts for the second NMOS transistor Q2 thereby protecting it from voltage break down.

The gate pull-down transistor Q3 requires protection from voltage breakdown, as well. A positive fault voltage of 40 volts on the output node 112 pulls the drain of the gate pull-down NMOS transistor Q3 to about 39 volts through the third body diode BD₃. This 40 volt fault voltage also causes the NPN bipolar transistor Q4 to conduct since its emitter is tied through the first resistor R1 to the substrate, which is held at zero volts. Conduction of the NPN bipolar transistor Q4 pulls the gate of the gate pull-down NMOS transistor Q3 to about 39 volts, as well.

Recall that the gate pull-down transistor Q3 is contained in the isolation structure 135, as shown symbolically in FIG. 1. The NPN bipolar transistor Q4 controls the voltage difference between the isolation structure 135 and the substrate to isolate the gate pull-down NMOS transistor Q3 and prevent it from experiencing voltage breakdown. A positive fault voltage of 40 volts on the output node 112 raises the isolation structure 135 to about 39 volts through activation of the NPN bipolar transistor Q4, as well. This provides an isolation environment for the gate pull-down NMOS transistor Q3 that is about one volt below the fault voltage of 40 volts, which allows adequate protection of the gate pull-down NMOS transistor Q3.

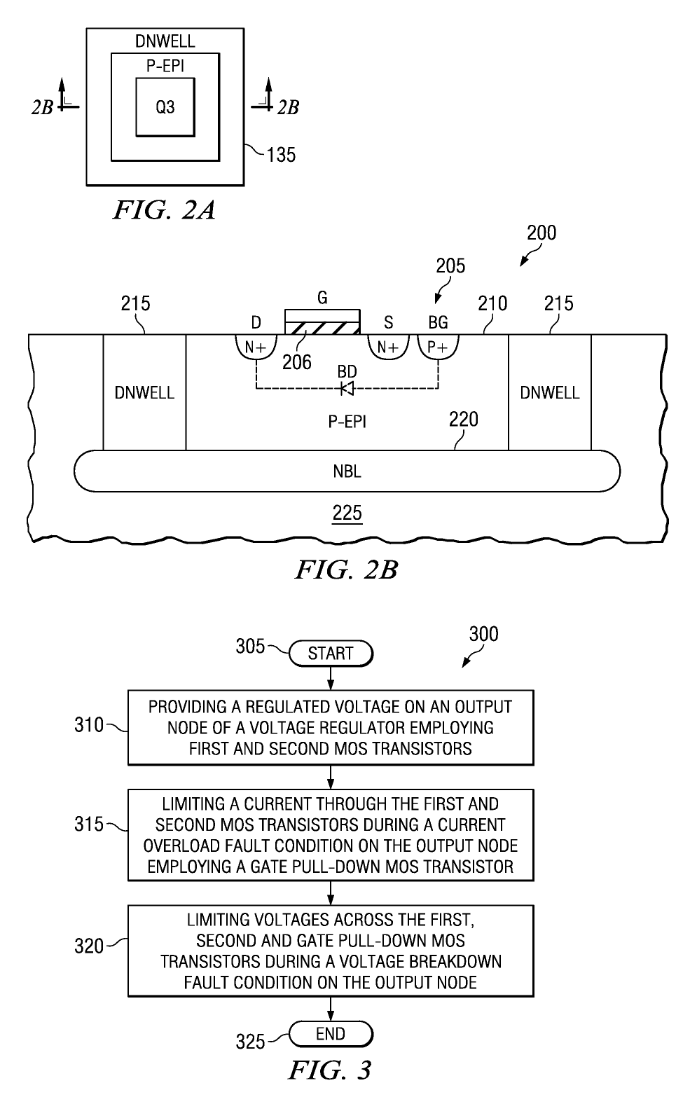

FIG. 2 illustrates a sectioned view of an isolation structure 200 containing a gate pull-down MOS transistor as may be employed with the voltage regulator 100 of FIG. 1. The isolation structure 200 includes a gate pull-down NMOS transistor 205 contained in a p-doped epitaxial region 210. The gate pull-down NMOS transistor 205 includes n-type source S and drain D areas separated by a gate region. An oxide layer 206 is employed between a gate G and the gate region, as shown. A p-type back gate BG (or bulk) connection to the p-doped epitaxial region 210 is also shown, as well as a body diode BD connection.

An outside portion of the isolation structure 200 is constructed of a surrounding DNWELL wall 215 and an n-type buried layer (NBL) 220 within a substrate 225. The p-doped epitaxial region 210 containing the gate pull-down NMOS transistor 205 form an inside or isolated portion of the isolation structure 200. The isolation structure 200 allows the p-doped epitaxial region 210 containing the gate pull-down NMOS transistor 205 to be isolated from (i.e., have a voltage different from) the substrate 225, which is held at zero volts in the present embodiment. When the connected source S and back gate BG experience a voltage breakdown fault condition, the isolation structure 200 is pulled to within about a volt of the applied fault voltage, as discussed with respect to FIG. 1.

FIG. 3 illustrates a flow diagram of an embodiment of a method of operating a fault protection circuit, generally designated 300, carried out according to the principles of the present disclosure. The method 300 is for use with a voltage regulator and starts in a step 305. Then, in a step 310, a regulated voltage is provided on an output node of the voltage regulator employing first and second MOS transistors. A current is limited through the first and second MOS transistors during a current overload fault condition on the output node employing a gate pull-down MOS transistor, in a step 315.

Generally, the current overload fault condition is a fault condition on the output node that would cause a current through the first and second MOS transistors to increase beyond control or without regulation or limit. In one embodiment, the gate pull-down MOS transistor has a lower threshold voltage than the first MOS transistor and is connected between a gate of the first MOS transistor and the output node of the regulator. This condition and arrangement allows the gate pull-down MOS transistor to provide a substantially shorted connection between the gate and source of the first MOS transistor thereby limiting its current or keeping it from conducting.

Then, in a step 320, voltages across the first, second and gate pull-down MOS transistors are limited during a voltage breakdown fault condition on the output node. Generally, the voltage breakdown fault condition is a fault condition on the output node that would cause voltages to increase beyond breakdown values across the first, second and gate pull-down MOS transistors.

In one embodiment, a body diode of the gate pull-down MOS transistor is employed in limiting the voltages across the first, second and gate pull-down MOS transistors during the voltage breakdown fault condition. In one embodiment, the gate pull-down MOS transistor is contained in an isolation structure that provides a voltage difference between the gate pull-down MOS transistor and the substrate during the voltage breakdown fault condition. In one embodiment, a bipolar transistor controls a value of the voltage difference corresponding to the voltage breakdown fault condition. The method 300 ends in a step 325.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which the disclosure relates will appreciate that other and further additions, deletions, substitutions and modifications may be made to the described example embodiments without departing from the disclosure.

What is claimed is:

1. A fault protection circuit for use with a voltage regulator, comprising:
an output power section having first and second MOS transistors configured to provide a regulated voltage on an output node of the voltage regulator; and
a gate pull-down section connected to the first and second MOS transistors and configured to provide a gate pull-down MOS transistor to limit a current through the first and second MOS transistors during a current overload fault condition on the output node.

2. The circuit as recited in claim 1 wherein the gate pull-down MOS transistor is connected between a gate of the first MOS transistor and the output node.

3. The circuit as recited in claim 1 wherein the gate pull-down MOS transistor has a lower threshold voltage than the first MOS transistor.

4. The circuit as recited in claim 1 further comprising an oxide protection section connected to the gate pull-down section and configured to limit voltages across the first, second and gate pull-down MOS transistors during a voltage breakdown fault condition on the output node.

5. The circuit as recited in claim 4 wherein a body diode of the gate pull-down MOS transistor is employed in limiting the voltages across the first, second and gate pull-down MOS transistors during the voltage breakdown fault condition.

6. The circuit as recited in claim 4 wherein the gate pull-down MOS transistor is contained in an isolation structure that is configured to provide a voltage difference between the gate pull-down MOS transistor and the substrate during the voltage breakdown fault condition.

7. The circuit as recited in claim 6 wherein a bipolar transistor is configured to control a value of the voltage difference corresponding to the voltage breakdown fault condition.

8. A method of operating a fault protection circuit for use with a voltage regulator, comprising:
providing a regulated voltage on an output node of the voltage regulator employing first and second MOS transistors; and
limiting a current through the first and second MOS transistors during a current overload fault condition on the output node employing a gate pull-down MOS transistor.

9. The method as recited in claim 8 wherein the gate pull-down MOS transistor is connected between a gate of the first MOS transistor and the output node.

10. The method as recited in claim 8 wherein the gate pull-down MOS transistor has a lower threshold voltage than the first MOS transistor.

11. The method as recited in claim 8 further comprising limiting voltages across the first, second and gate pull-down MOS transistors during a voltage breakdown fault condition on the output node.

12. The method as recited in claim 11 wherein a body diode of the gate pull-down MOS transistor is employed in limiting the voltages across the first, second and gate pull-down MOS transistors during the voltage breakdown fault condition.

13. The method as recited in claim 11 wherein the gate pull-down MOS transistor is contained in an isolation structure that provides a voltage difference between the gate pull-down MOS transistor and the substrate during the voltage breakdown fault condition.

14. The method as recited in claim 13 wherein a bipolar transistor controls a value of the voltage difference corresponding to the voltage breakdown fault condition.

15. A voltage regulator, comprising:
an error amplifier having a control signal output, a first differential input connected to a reference voltage and a second differential input connected to an error signal;
an error signal generator that provides the error signal corresponding to an error in a regulated voltage on an output node of the voltage regulator; and
a fault protection circuit connected to the control signal output, including:
an output power section having first and second MOS transistors that provide a regulated voltage on an output node of the voltage regulator,
a gate pull-down section connected to the first and second MOS transistors that provides a gate pull-down MOS transistor to limit a current through the first and second MOS transistors during a current overload fault condition on the output node, and
an oxide protection section connected to the gate pull-down section that limits voltages across the first, second and gate pull-down MOS transistors during a voltage breakdown fault condition on the output node.

16. The voltage regulator as recited in claim 15 wherein the gate pull-down MOS transistor is connected between a gate of the first MOS transistor and the output node.

17. The voltage regulator as recited in claim 15 wherein the gate pull-down MOS transistor has a lower threshold voltage than the first MOS transistor.

18. The voltage regulator as recited in claim 15 wherein a body diode of the gate pull-down MOS transistor is employed in limiting the voltages across the first, second and gate pull-down MOS transistors during the voltage breakdown fault condition.

19. The voltage regulator as recited in claim 15 wherein the gate pull-down MOS transistor is contained in an isolation structure that provides a voltage difference between the gate pull-down MOS transistor and the substrate during the voltage breakdown fault condition.

20. The voltage regulator as recited in claim 15 wherein a bipolar transistor controls a value of the voltage difference corresponding to the voltage breakdown fault condition.
